(19) United States
(12) Patent Application Publication
(10) Pub. No.: US 2004/0026636 A1
(43) Pub. Date: Feb. 12, 2004

(54) Device and method for inspecting playing card and playing card used therefor

(76) Inventor: Yasushi Shigeta, Osaka-shi (JP)

Correspondence Address: FINNEGAN, HENDERSON, FARABOW, GARRETT & DUNNER, LLP, 1300 I STREET, NW, WASHINGTON, DC, 20005, US

(21) Appl. No.: 10/399,754

(22) PCT Filed: Feb. 6, 2002
(86) PCT No.: PCT/JP02/00985

(30) Foreign Application Priority Data
Feb. 15, 2001 (JP) 2001-037908

(51) Int. Cl. G06K 5/00; G01N 21/86

(52) U.S. Cl. 250/556; 250/559.01

(57) ABSTRACT

In the present invention, an identification code representing that a playing card constitutes a prescribed group is given to the playing card in order to discover an abnormal playing card mingled in with genuine playing cards for illicit purposes. The identification code is read from each of a plurality of playing cards constituting the prescribed group so as to determine whether the playing card is a genuine playing card or an abnormal playing card. The identification code may be provided on the playing card in a condition invisible to the human eye under normal usage conditions.

### TECHNICAL FIELD

The present invention relates to a technique to inspect (discern) whether or not an abnormal card not constituting a prescribed group is included in a group of playing cards.

### BACKGROUND ART

In a playing room of a casino, a plurality of playing corners are set up and games are played by playing cards in each corner. In such a casino, a proprietor monitors the games for any illicit game. A player may engages in an illicit game by tampering with cards or bringing into the game playing cards prepared by the player.

Conventionally, the cards are inspected manually in order to find such illicit playing cards. Concretely, by confirming the suit (spades, hearts, diamonds and clubs) and rank (A, 2, . . . , 10, J, Q, K) of playing cards constituting a deck, whether or not an illicit card is mingled in with the deck of cards is discerned.

The above conventional inspection method is able to discover an illicit act conducted in games in which a certain deck of cards is used, if an illicit card is only mingled in the deck of cards, or a card is only removed from the deck of cards. However, when an illicit card is mingled in a deck of cards and a genuine card corresponding to the illicit card, that is, the card of same suit and rank as the illicit card, is removed from the deck of card, the illicit act conducted in the game in which the deck of cards in question is used cannot be discovered. Ordinarily, the illicit card is visually almost identical to other cards.

Also, with the manual inspection, there is a problem of increase in personal expense as well as slowing down in work speed. Furthermore, there is a possibility that a person who performs the inspection work himself will performs illicit acts and a problem of low reliability of the inspection.

Especially, due to improvement of quality of the playing cards, as the cards can be used for a long time, for example, for about two weeks, the number of inspections for the purpose of reusing the used playing cards is increased, and improvement of its workability and reliability and cost reduction become a major problem.

Thus, the purpose of the present invention is to provide an inspection technique for playing cards capable of determining whether or not an illicit card is mingled in a deck of cards, and also for the purpose of providing playing cards preferably used in the inspection. The purpose of the present invention is also particularly to provide an inspection technique capable of properly discovering an illicit card that appears to be a proper card on ordinary viewing, and to provide playing cards preferably used in the inspection technique.

Furthermore, the purpose of the present invention is to suppress personnel expense and to improve work speed in the inspection of playing cards, or to improve the reliability of inspection.

### DISCLOSURE OF INVENTION

In order to accomplish the above purposes, the inspection apparatus covered by the present invention is an inspection apparatus for inspecting playing cards, comprising a code reader for reading out an identification code which is the identification provided on playing cards representing a prescribed deck, to yield readout data, and a determination device for determining whether or not an abnormal playing card not constituting a prescribed group of a plurality of playing cards is included.

With this inspection apparatus, a playing card brought in by a dishonest player as an illicit card is identified as the abnormal card. Moreover, in the present invention, the read out includes all processes to recognize the content of the identification code such as to electromagnetically read the identification code provided magnetically in the playing card in addition to optically read out the identification code that appears as an image.

If this inspection apparatus is introduced in a casino which uses a playing card provided with different identification codes for each prescribed group consisting of one deck or a plurality of decks of cards, when the illicit card is mingled in a plurality of playing cards belonging to the prescribed group, a manager of the casino is able to recognize a set of cards in which the illicit card is mingled, as an abnormal set. Especially, when a dishonest player steals a playing card used on a table and uses the card illicitly on a different table, the mingling of the abnormal card that cannot be determined only by its design, can be discovered by reading the identification code.

In the present invention, all playing cards classified by the identification code may not be inspected by a single inspection. For example, when an identification code is assigned to a group comprising 1,000 decks of card, only a few decks of card may be subjected to the inspection. In such a case, if an abnormal playing card which does not constitute the group in a plurality of playing cards is subjected to the inspection, the abnormal card will be discovered.

By this inspection apparatus, the workability of inspection of the playing card is improved as well as its reliability, leading to further reduction of cost.

Preferably, the identification code is established on the playing card in a condition invisible to the human eye under the normal usage conditions.

With this method, without obstructing the original use of the playing card, the determination by the identification code of mingling of the abnormal card becomes possible. That is to say, on the front face of a playing card, only an inscription of the kind comprising the suits and ranks, and the reverse face showing a design appearing to be a conventional normal playing card, that is, a playing card appearing to be totally identical to the naked eye, which does not constitute a group may be utilized. As a result, casino players can utilize the playing card without any sense of incongruity, and the casino proprietor would be able to easily introduce this technology.

Moreover, the condition invisible to human vision under normal usage condition, means, for example, a condition in which the identification code is printed by special ink on the face of the playing card which can be seen by the human eye only when exposed to prescribed light, or a condition where the identification code is given as magnetic information on the playing card.

Preferably, the above determination device comprises a light source to shine prescribed light on a playing card, and the above identification code becomes readable by the code reading device upon receiving the prescribed light.

Preferably, the above inspection apparatus is further equipped with an alarm device for reporting the determination result by the determination device.

In this way, an operator of the inspection apparatus is able to easily learn that an abnormal card is mingled in a plurality of inspected playing cards. As the means of alarm, it may be something catching the eye of the operator (for example, reporting by monitor indication) or the ear (for example, reporting by buzzing sound), or noticeable by other sensory organs.

Preferably, the inspection apparatus further comprises the suit indication readout device for reading out the suit indication of a playing card, and the reporting device is a monitor for indicating a result of the determination, and reporting the suit of the abnormal playing card by indicating on the monitor the suits read out by the above suit indication readout device.

In this way, the operator of the inspection apparatus is able to visually recognize that the abnormal playing card is mingled.

Preferably, the determination device determines that the abnormal playing card, which does not constitute the prescribed group, is included in the plurality of playing cards when the code readout device cannot read out the identification code of either one of the plurality of playing cards.

In this way, if a dishonest player brings in from outside a playing card without the identification code, that is, an illicit playing card brought in from outside of the casino, this can be determined as the abnormal playing card.

Preferably, the above inspection apparatus further comprises a normal identification code memory device for storing the normal identification code corresponding to the prescribed group, and the determination device compares the identification code read out by the code readout device with the normal identification code stored in the normal identification code memory device, and when the identification code and the normal identification code do not match, determines that an abnormal playing card which does not constitute the prescribed group is included in the plurality of playing cards.

With this inspection apparatus, the normal identification code which is a reference standard is first specified, and depending on whether or not the plurality of playing cards under inspection match the specified normal identification code, the determination of the abnormal playing card is made.

Preferably, the memory device stores the identification code read out by the code readout device as the normal identification code.

According to this inspection apparatus, the code readout device may be used concurrently with means for specifying the normal identification code to simplify the structure of the apparatus, in addition to use it as means for reading out the identification code from the playing card subject to inspection.

Preferably, the identification code stored as the normal identification code is the most numerous identification code among identification codes read out from the plurality of playing cards.

In this apparatus, the most numerous identification codes will be the normal identification code as the standard. Therefore, even if the operator of the inspection apparatus does not recognize the normal identification code, regarding a plurality of playing cards, the operator is able to determine whether or not any abnormal playing card exists. That is, at the time of implementing the inspection, there is no necessity to recognize in advance the normal identification code on the subjected to inspection.

Preferably, the identification code stored as the normal identification code is the identification code which is read out at first regarding the plurality of playing cards.

It is assumed that a majority of the plurality of playing cards which are subjected to identification will be normal playing cards, and the identification code which is readout initially may be considered as the normal identification code.

If an abnormal playing card is readout at first and made the normal identification code, a playing card which should actually be normal may be determined to be an abnormal playing card. However, even in such a case, it may be determined ultimately that there is a playing card illegitimately mingled in with the plurality of playing cards which are subjected to inspection.

Furthermore, if the identification code which is read at first and stored as the normal identification code is made the identification code read from a sample card different from the plurality of playing cards, the above problem would be resolved.

Preferably, the above inspection apparatus comprises an input device for the operator to input the identification code, and the identification code to be stored as the normal identification code is the identification code input from the input device.

Preferably, the prescribed group is composed of a plurality of decks, and the plurality of decks have respectively different normal identification codes, and in case that the identification code readout by the code readout device does not match any of above respective codes, the determination device may determine that an abnormal playing card which does not constitute the prescribed groups is included in the plurality of playing cards.

Several decks of playing card may be used as one set. In such a case, according to the present inspection apparatus, each deck may have a different identification code. For example, even if a plurality of playing cards subject to inspection consist of 4 decks, and the identification code differs for each deck, these 4 identification codes are all treated as normal identification codes, and a card which does not have any of these four identification codes may be determined to be an abnormal playing card.

Preferably, by comparing identification codes respectively read out from plural playing cards by the code readout device, the determination device determines that an abnormal playing card which does not constitute the prescribed group is included in the plurality of playing cards.

Using this inspection apparatus, it can be determined that an abnormal card is mingled, except when the identification code of a plurality of playing cards which are subjected to inspection are matched.

Preferably, the inspection apparatus further comprises a pick out means for picking out the abnormal playing card which does not constitute the prescribed group.

As a result, it is possible to confirm which playing card is the mingled abnormal playing card.

Preferably, the means for picking out the abnormal playing card picks out the abnormal playing card by placing the abnormal card, for which the read out by the readout device is finished, is arranged at a different place from other playing cards.

With this inspection apparatus, the abnormal playing card can be picked out easily.

Preferably, the inspection apparatus comprises a transporting device for sending the plurality of playing cards in order to the code readout device, and the pick out means picks out the abnormal playing card by stopping the motion of the transporting device when the determination device determines that the abnormal playing card is included.

With this inspection apparatus, the abnormal card may be easily picked out and the time used for the inspection may be shortened.

Preferably, the above inspection apparatus further comprises a design readout device for reading the design appearing on the plurality of playing cards, and the determination device further determines, based on the design read out by the design readout device, that the abnormal playing card which does not constitute the prescribed group is included in the plurality of playing cards.

With this inspection apparatus, since mingling of the abnormal card is determined by the identification code and design, the same identification code maybe allocated to playing cards of different design.

Preferably, the above inspection apparatus further comprises a suit indication readout device for reading the suit indication of a playing card indicated on a reverse side of a side where the design is indicated, and the code readout device, the design readout device, and the suit indication readout device are a common readout device, and comprises a mirror reflecting the design or the suit indication toward the common readout device.

With this apparatus, since it comprises the mirror, both the design and suit indication that actually appear on separate sides can be read by the common readout device. Thus, it is not necessary to provide a separate readout device to read each side and simplifying and cost reduction of the apparatus structure can be achieved. Moreover, in that case, the identification code may be provided on either side of the playing card. When the identification code cannot be read directly by the common image device, this identification code may be read by the mirror.

Preferably, the above inspection apparatus comprises a stacker for stacking the plurality of playing cards and at least one pair of rollers, and further comprises a carrying device for orderly carrying of playing cards stacked in the stacker by the pair of rollers to a position opposite to the common readout device. The mirror reflects the design or suit indication toward the common readout device on the free edge side of the playing cards held by the pair of rollers.

With this structure, the apparatus can be miniaturized.

For the purpose of accomplishing above objective, the playing card covered by the present invention is given information on the identification code which is identifiable by an identification devise and representing a group to which the playing card belongs, which cannot be seen by human vision under normal usage condition.

With this playing card, although under normal usage conditions the playing card itself cannot be discerned from a conventional playing card by a person, when an abnormal playing card is mingled in a group of playing cards, the mingling of such an abnormal card can be determined from the use of a prescribed identification device. Therefore, a casino in which this playing card is used, is able to, for example, discover that a playing card is brought into a game illegitimately from another table without giving a sense of incongruity or causing any trouble to utilizers (players in casino). Also, according to this playing card, even it there are plurality of playing cards of the same design with all suits and ranks, if an abnormal card is included therein, it can be determined. Regarding this point, compared with an inspection apparatus which merely determines whether or not the suits and ranks are all in order, a more skillful illegitimate act, that is, an illegitimate act of not only mingling an illegitimate card but also removing a legitimate card of the same suit and rank can be discovered.

Preferably, there are at least two of the identification codes for the above playing card, and these two identification codes are in point symmetry as to be at the center of a playing card.

By making it in such structure, the identification code is identified at the designated position of the playing card irrespective of which way up the playing card is facing. Moreover, if there are at least two identification codes, the third identification code not related to the point symmetry may be established, or two other identification codes in a position of point symmetry may further be established.

Preferably, in the above playing card, the identification code is printed using paint which becomes visible under the prescribed light.

There are many methods of providing information for an identification code on the playing card, but the method of printing it with such paint is one method to keep the manufacturing cost as low as possible.

Preferably, in the above playing card, the identification code may be printed using a bar code.

With this construction, the readout of the identification code becomes easy and reliable.

Preferably, in the above playing card, the identification code is printed at a position not overlapping the suit indication of the playing card.

With this construction, when the identification code is to be read, the identification code and suit indication may be read clearly.

Preferably, in the above playing card, the identification code comprises information inherent to the group and information on manufacturing date of that group.

With this construction, if information of the same group is given to a group having different manufacturing date, the identification code as a whole represents a specific group.

Preferably, in the above playing card, the identification code comprises the casino information inherent to the casino where the playing card is used.

Also, for the purpose of accomplishing the above objective, the inspection method covered by the present invention is an inspection method for inspecting several playing cards, having a process to read the identification code provided on the playing cards as a code to represent its group, and a process to determine that, as a result of the above read out, an abnormal playing card which does not constitute the prescribed group is included in several playing cards covered by the inspection.

### BRIEF EXPLANATION OF DRAWINGS

FIG. 1 is a general view of a playing card in a condition where ultraviolet light is not irradiated (normal usage conditions).

FIG. 2 is a general view of a playing card in FIG. 1 where ultraviolet light is irradiated.

FIG. 3 is a general view of another example of a playing card in a condition where ultraviolet light is not irradiated (normal usage conditions).

FIG. 4 is a general view of a playing card in FIG. 3 where ultraviolet light is irradiated.

FIG. 5 is a drawing showing an example of the information contained in the playing card.

FIG. 6 is a general side view drawing showing the first embodiment of the inspection apparatus.

FIG. 7 is a general plane drawing of the inspection apparatus of FIG. 6.

FIG. 8 is a block drawing showing the functional structure of the inspection apparatus.

FIG. 9 is a flow chart of a first embodiment of the inspection process.

FIG. 10 is a flow chart of the first embodiment of the normal identification code specific process.

FIG. 11 is a flow chart of the first embodiment of the determination process.

FIG. 12 is a drawing showing the first indication example of the operation panel.

FIG. 13 is a flow chart of the second embodiment of the normal identification code specific process.

FIG. 14 is a drawing showing the second indication example of the operation panel.

FIG. 15 is a flow chart of the third embodiment of the normal identification code specific process.

FIG. 16 is a drawing showing the third indication example of the operation panel.

FIG. 17 is a flow chart of the second determination process.

FIG. 18 is a flow chart of the fourth embodiment of the normal identification code specific process.

FIG. 19 is a flow chart of the third embodiment of the determination process.

FIG. 20 is a drawing showing the fourth indication example of the operation panel.

FIG. 21 is a flow chart of the second embodiment of the second inspection process.

FIG. 22 is a general side view drawing showing the second embodiment of the inspection apparatus.

FIG. 23 is a general side view drawing showing the third embodiment of the inspection apparatus.

FIG. 24 is a general side view drawing showing the fourth embodiment of the inspection apparatus.

FIG. 25 is a conceptual drawing of a determination process for a playing card.

FIG. 26 is a conceptual drawing of a determination process for a playing card.

FIG. 27 is a conceptual drawing of a determination process for a playing card.

### BEST MODE OF EMBODYING THE INVENTION

The preferred embodiments of the present invention will be explained with reference to the drawings.

[A Playing Card]

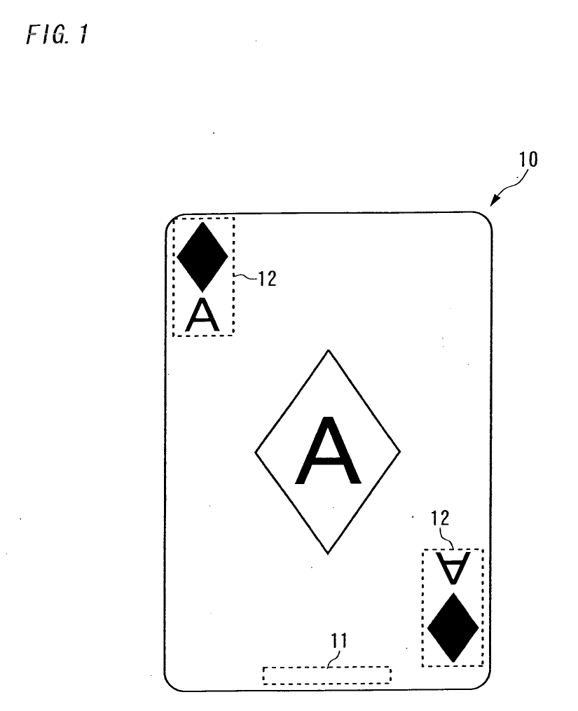

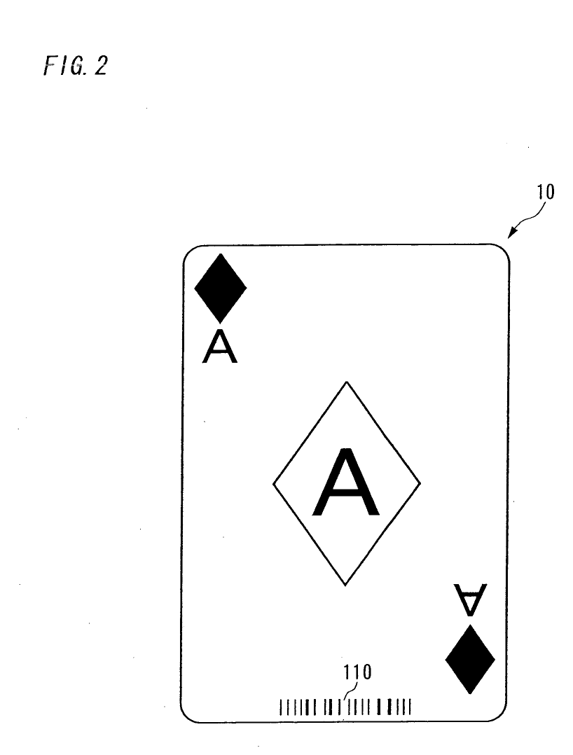

FIG. 1 is a general drawing of the front side of a playing card under normal usage conditions. FIG. 2 is a general view when ultraviolet light is irradiated as a special ray on the playing card of FIG. 1. The front side of a playing card 10 is provided with an identification code recording section 11 in which the identification code is recorded in a condition which cannot be seen by human vision under the normal usage conditions, and a suit indication section 12 which indicates any of spades, hearts, diamonds and clubs, and A, 2, . . . 10, J, Q, and K as the rank (value).

In the present specification and claims, the “suit” means the suit and rank of the playing card, and “suit indication” means the indication indicating the suit and rank appearing on the front side of the playing card. Also, the “design” means the design appearing on the back of the playing card. Playing cards forming one deck have different suit indications on their respective faces but the design on the back is same. In a normal playing card game, only one deck is used, but in a casino, a game is played by using a plurality of decks of the same design.

The identification code recording section 11 is provided at the edge in a lengthwise direction of the playing card. On the identification code recording section 11, a bar code 110 is provided as an identification code. The bar code 110 is printed on a playing card 10 using ink which develops color under ultraviolet light which can be seen by the naked eye when ultraviolet light is irradiated.

Also, as depicted in FIG. 1, the identification code recording section 11, is provided at a place not overlapping the suit indication section 12. Moreover, as depicted in FIG. 1 and FIG. 2, the playing card indicates the suit by using suit marks in the number of ranks the same as the conventional playing card. It is possible to use this as the suit indication section.

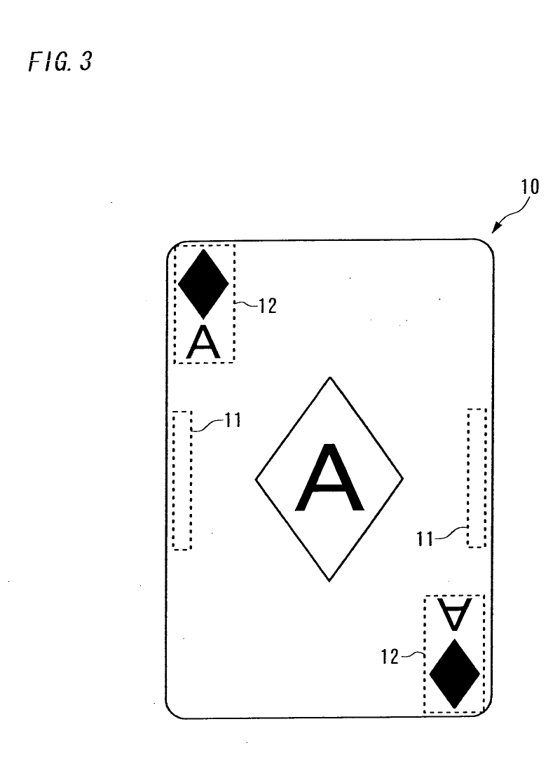

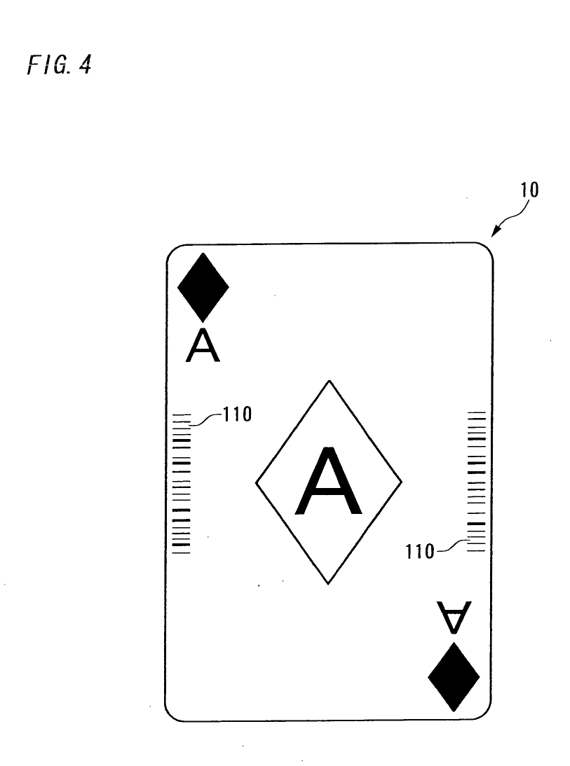

FIG. 3 is a general view of normal usage conditions of a front side of the playing card of other examples. FIG. 4 is a general view when ultraviolet light is irradiated on the playing card of FIG. 3. In examples of FIG. 3 and FIG. 4, the identification code recording section 11 is provided near both long sides of the playing card 10. On the playing card 10, two bar codes 110 are printed on both edges in the direction of a short side of the playing card.

There are two identification code recorded sections 11 at positions of point symmetry in relation to the center of the playing card 10, and the same identification code is used at both identification code recording sections 11.

If the identification code recording section 11 is provided at one place, at the time of carrying out inspection using the inspection apparatus as explained later, the direction of a plurality of playing cards having upper and lower sides different from each other must be arranged in order so as to make the position of single identification codes at a prescribed position. Such work is complicated. Also, the identification code cannot be seen under the normal usage conditions, and it is difficult to arrange the position of a single identification code in order. Furthermore, as there are playing cards with a design without distinction of up and down (for an example, four diamonds), the direction of the playing card cannot be placed in order relying on the design of the playing card.

Against the above, for playing cards with only a single identification code, it is possible to read two places of the playing card, at one of which the identification code exists (which can always be read only from one of the sides), and to adopt the identification code which can be read, but this is not preferable as the structure of the inspection apparatus becomes complicated.

With the playing card 10 indicated in FIG. 3 and FIG. 4, two identification codes 110 are provided at position of point symmetry in relation to the center of the playing card. In this way, regardless of whether each of the playing cards to be inspected is facing either up or down, the inspection apparatus is able to discover the identification code at the prescribed position. According to this structure, there is an advantage of being able to perform the inspection based on the readout of identification code without complicating the inspection work or without complicating the inspection apparatus.

In addition to two identification codes at the positions of point symmetry, the same identification code may further be provided at a different position, or another pair of two identification codes may further be provided at the positions of point symmetry.

In the case of reading out the bar codes 110 and 110 using the inspection apparatus, when both codes are read out, and even if one of them is unreadable and the other is readable, it may be determined that the card is a normal card. Also, when the content of a code comprising the bar code is large, the bar code is printed by dividing the code in two places, or alternately both code data may be one data.

The identification code may be printed using ink which becomes visible by ultraviolet light or other ink such as ink which becomes visible by infrared light. Further, in the above example, the bar code is printed using ink which is not visible to the human eye under the normal usage conditions, but this is not limiting and the bar code may be printed using ink visible to human vision under the normal usage conditions. When the bar code 110 is printed using such visible ink, it does not affect the game itself although there is a sense of incongruity. This is effective the card can be made at a cheap price.

When the identification code is provided electromagnetically, the magnetized portion may appear in black on the playing card. In such a case, a person may visually judge that a sort of identification code is being used under the normal usage conditions, but cannot see what the identification code is. That is to say, with human vision, the magnetized portion to which information of identification code is applied and the magnetized portion to which information of other identification code is applied cannot be distinguished. Such a condition is the condition “which cannot be seen by human vision under normal usage conditions”.

Also, in addition to the example of FIG. 1 through FIG. 4, the identification code recording section 11, may be provided on the reverse side of the playing card 10. Furthermore, by applying information of an identification code to an IC chip incorporated in the playing card, the identification code section 11 may be established in the playing card 11.

The identification code may be comprised by numerical figures or marks, and not only by the bar code, and they may also be used in a mixed manner.

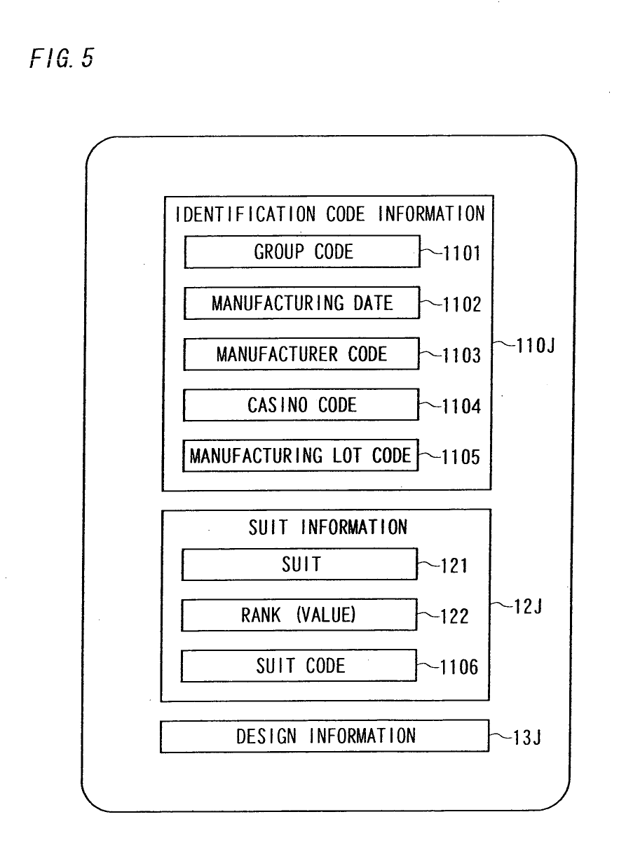

FIG. 5 is a figure representing the information contained in the playing card 10. Each playing card 10 has, as information contained therein, the identification code information 110J representing the group to which the playing card belongs, the suit information 12J representing the suit of that playing card, and the design information 13J representing the design of the playing card. When one deck of playing cards constitutes one group, the identification code information 110J representing a group differs for each deck, and when plural decks of playing cards constitute one group, the identification code information 110J representing the group is common to plural decks constituting the group.

The identification code information 110J consists of the group code information 1101 assigned inherently to the group to which the playing card 10 belongs, manufacturing date code information 1102, manufacturer code information 1103, casino code information 1104 and manufacturing lot code information 1105.

Here, the group code 1101 is commonly assigned to, for example, 100 decks or 1,000 decks of playing cards, or assigned inherently to each deck. That is to say, a group may, for example, consist of 1,000 decks, or one deck.

Furthermore, at an actual inspection, as described later, for an example, one deck, 4 decks or 8 decks of playing cards are subject to inspection, and the plurality of playing cards subject to inspection do not always coincide with the group classified by the identification code. For example, when the common identification code is assigned to 1,000 decks of playing cards, only 8 decks out of 1,000 decks are subject to inspection as a group. Also, when an inherent identification code is assigned to one deck of playing cards, there may be a case in which four decks of playing cards with different identification codes are subject to the inspection as one group. In either case, the inspection based on the identification code is possible using the inspection process that will be described later.

As for the group code information 1101, at least in the same manufacturing date code, they are group codes wherein each group has a different group code. In this way, for the identification code overall, an inherent code is assigned to that group.

As to the suit information 12J, it consists of the suit information 121 and rank information 122 included in the suit indication section 12, and the suit code information 1106 recorded in an invisible state under the normal usage conditions the same as the identification code 110. The suit code information 1106 may be provided at the same place as the identification code 110, or included in the identification code 110.

The design information 13J is the image information possessed by the design itself on the reverse side of the playing card 10.

[First Inspection Apparatus]

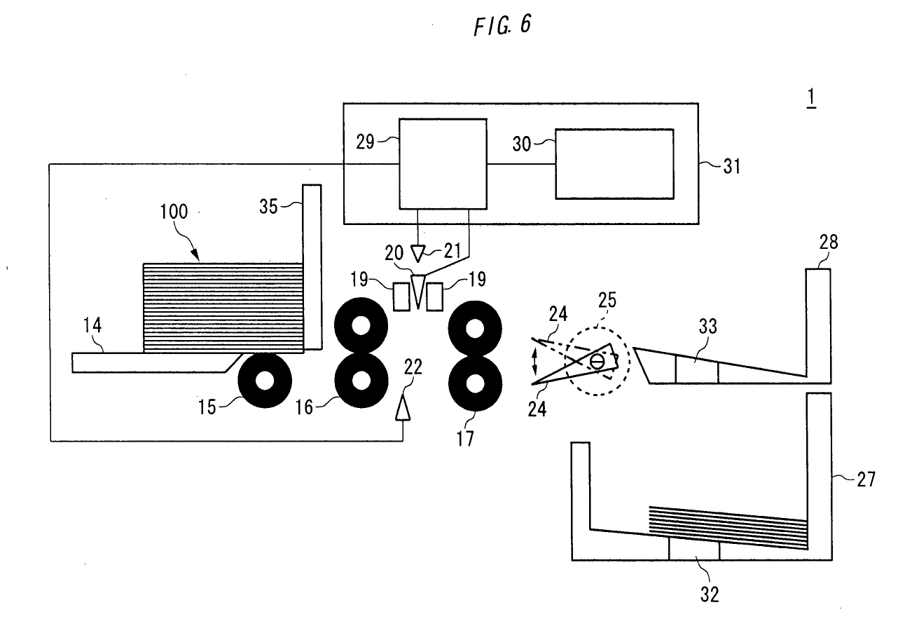

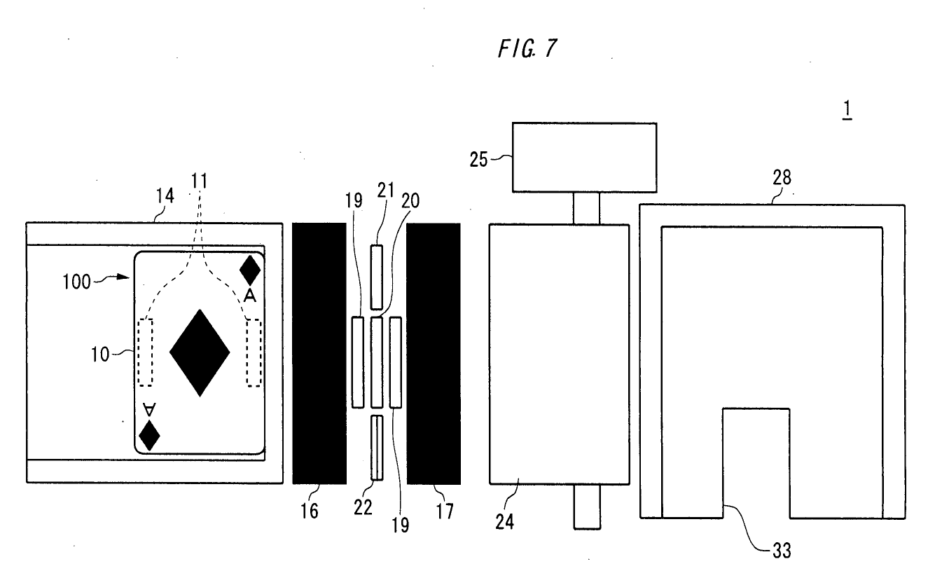

FIG. 6 is a general side view drawing showing the first embodiment of the inspection apparatus. FIG. 7 is a general plane drawing of the inspection apparatus of FIG. 6. The inspection apparatus 1 indicated in FIG. 6 and FIG. 7 is designed as an apparatus to inspect the playing card 10 of the type in FIG. 3 and FIG. 4.

The inspection apparatus 1 for the playing card has a card set table 14 for placing a bundle 100 of the playing cards 10 which is the subject of the inspection, and a carrying out roller 15 for send out the playing cards one by one from the bottom of the card bundle. The playing card 10 which is the subject of inspection is set on the card set table 14 with its front side, on which the suit and rank are indicated and the identification code is printed, on top.

Also, the inspection apparatus 1 has carrying rollers 16 and 17 provided with an appropriate space for carrying the playing card 10 sent out from the card set table 14, an ultraviolet lamp 19 for irradiating ultraviolet light (black light) onto the identification code recording section 11 of the playing card 10 provided above between the carrying roller 16 and the carrying roller 17, an ultraviolet light sensor 20 for producing readout data by reading the bar code 110 emitting color upon irradiation with ultraviolet light, provided between the ultraviolet lamps 19, a CCD camera 21 for producing readout data by reading the suit indication of the playing card 10, and a CCD camera 22 for reading out the form of design of the playing card 12, provided below between the carrying roller 16 and the carrying roller 17.

The above ultraviolet light sensor 20 may be used as the CCD camera for photographing the identification code device irradiated with ultraviolet light by the ultraviolet lamp 19. The ultraviolet light sensor 20 is suitable for readout when the identification code is a bar code as stated above, and on the other hand, the CCD camera is suitable for reading the above identification codes when they are printed in the form of numerical figures or marks using the above described special ink.

The playing card 10 carried out from the card set table 14 by the carrying out roller 15, is carried by the carrying roller 16 to a position opposite to the ultraviolet light sensor 20, etc. the ultraviolet light sensor 20, CCD camera 21 and CCD camera 22 read out the prescribed portion of the playing card at an appropriate timing.

Furthermore, for the purpose of picking out an abnormal card, the inspection apparatus 1 has a sorting piece 24 which rotates up and down to switch the direction in which the normal cards and an abnormal card advance, a rotary solenoid 25 which rotatably drives the sorting piece 24, a normal card stacker 27 for stacking the normal cards, and an abnormal card stacker 28 for stacking any abnormal cards. Holes 32 and 33 through which a finger can be inserted out are provided so as to be able to easily take out the playing cards 10 on the normal card stacker 27 and abnormal card stacker 28, respectively.

The inspection apparatus 1 also has a control device 31 for executing various processes such as judging distinction of the normal card and abnormal card by storing the readout data produced by the ultraviolet light sensor 20, CCD camera 21 and CCD camera 22. The control device 31 comprises a computer, and has a memory determination unit 29 and a monitor 30 for reporting the determination result from a memory determination unit 29. The monitor 30 is an operation panel of the touch panel type, having a function of receiving input from the operator.

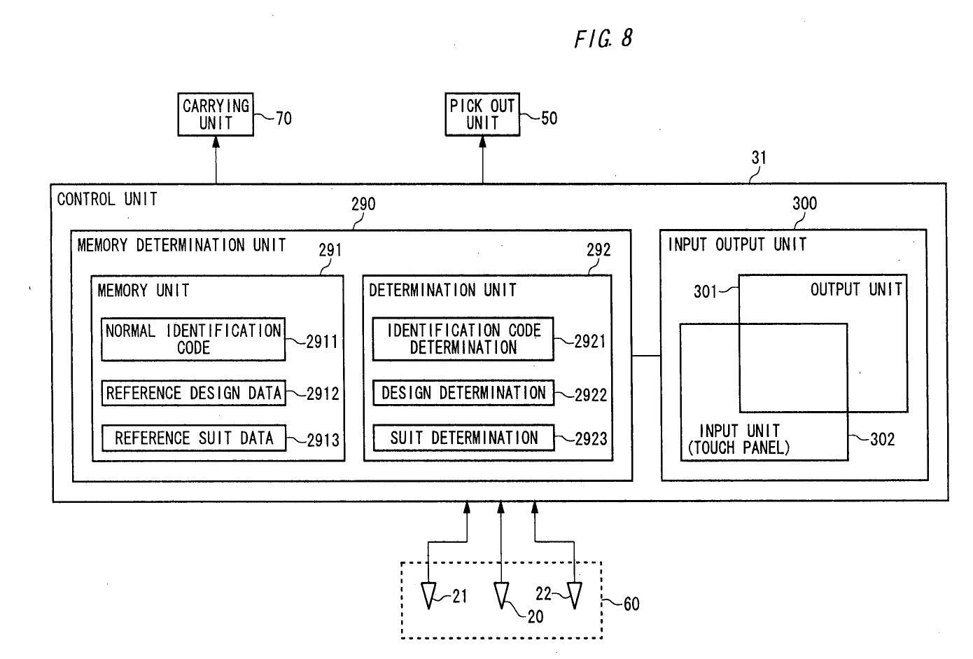

FIG. 8 is a block diagram representing the functional structure of the inspection apparatus 1. The inspection apparatus 1 has a control unit 31, a pick out unit 50, a readout unit 60, and a carrying unit 70. The pick out unit corresponds to the sorting piece 24, the rotary solenoid 25, the normal card stacker 27 and the abnormal card stacker 28 in FIG. 6 and FIG. 7, and assumes the function of being able to specify the playing card to be picked out as the abnormal card.

The readout unit 60 corresponding to the ultraviolet light sensor 20 and the CCD cameras 21 and 22, and reads out a specific place of the playing card 10 and assumes the function of producing and sending the read out data to the control unit 31. Concretely, at the readout unit 60, the identification code readout data is produced when the ultraviolet light sensor 20 reads out the identification code, the suit readout data is produced from the reading out of suit indication by the CCD camera 21, and the design readout data is produced from the reading out of the design by CCD camera 22.

The carrying unit 70 corresponds to the carrying out roller 15, carrying rollers 16 and 17, and their driving motors, and assumes the function of carrying the playing cards 10 set on the card set table 14 to readout the identification code, etc. one by one in an orderly manner.

The pick out unit 50, the readout unit 60 and the carrying unit 70 are electrically connected to the control unit 31, and are controlled by the control device.

The control unit 31 has a memory determination unit 290 and an input and output unit 300. The memory determination unit 290 corresponds to the determination unit 29. The memory determination unit 290 is further divided into a memory unit and a determination unit 292. The memory unit 291 has the normal identification code memory unit 2911 for storing the normal identification code as a standard code, a reference design data memory unit 2912 for storing the reference design data which constitutes standard design image data, and a reference suit data memory unit 2913 for storing suit image data to be criteria as a reference suit data for all suits and ranks.

The determination unit 292 has an identification code determination unit 2921 which determines whether or not the playing card 10 is normal or abnormal by comparing the identification code readout data produced by and sent from the ultraviolet light sensor 20 of the readout unit 60 with the normal identification code stored in the normal identification code memory unit 2911, a design determination unit 2922 which determines whether or not the playing card 10 is normal or abnormal by comparing the design readout data produced by and sent from the CCD camera 22 of the readout unit 60 with the reference design data stored in the reference design data memory unit 2912, and a suit determination unit 2923 which specifies the suit of the playing card 10 which is readout by collating the suit readout data produced by and sent from the CCD camera 21 of the readout unit 60 with the reference suit data stored in the reference suit data memory unit 2913.

The determination unit 292 performs a process of recognizing the identification code read out by analyzing each item of readout data sent from the readout unit 60. If an image to be determined as the identification code by the ultraviolet light sensor 20 is not detected, the determination unit 292 recognizes that the identification code represents an error (error code). That is to say, in the case where a playing card which does not have the identification code (a card brought in from outside) or a playing card whose identification is damaged is read out by the readout unit 60, it is recognized as an error code. This error code does not match any identification codes presently used.

The input and output unit 300 corresponds to the monitor 30 which is also an operation panel of the touch panel type, and functionally includes the output unit 301 and the input unit 302. The output unit 301 displays the inspection result or a button, etc. as the touch panel, and the input device accepts the input from the operator corresponding to the output content from the output unit 301. In this specification, the monitor 30 may be called an “operation panel 30”.

[First Inspection Process]

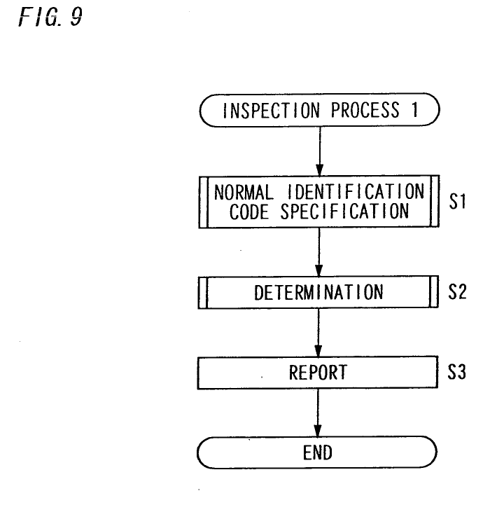

FIG. 9 is a flow chart of the First Inspection Process (the inspection process 1) for inspecting a bundle 100 of a plurality of playing cards 10 using the inspection apparatus 1. In the inspection process 1, first of all, the normal identification code is specified (step S1), and it is determined whether or not each playing card is normal or abnormal based on the normal determination code specified in the step S1 (step S2) on the plurality of playing cards subject to inspection, and the determination result thereof is reported (step S3). A group determined as abnormal may be abandoned and a group determined as normal may be reused.

The inspection process 1 is explained hereafter as a process of inspecting playing cards of four mixed up decks as a group.

The normal identification code specified in the step S1 is stored in the normal identification code memory device 2911. Here, only one identification code may be given to a group consisting of four decks of playing cards, or different identification codes may be given to each of the four decks. In the former case, there is only one normal identification code specified, while in the latter case, four normal identification codes are specified.

As there are various modes for the process of specifying the normal identification code in step S1 and making the determination in step S2, these will now be explained in order.

[First Embodiment of the First Inspection Process]

First of all, in the first embodiment, the identification code 110 is readout respectively from a plurality of playing cards 10 subject to inspection, and the normal identification code that exists in the greatest number is specified. Then, the identification code 110 is read out again from the plurality of playing cards 10 and by determining whether or not it matches with the normal identification code specified previously, the determination is made as to whether each of playing cards 10 is normal or abnormal.

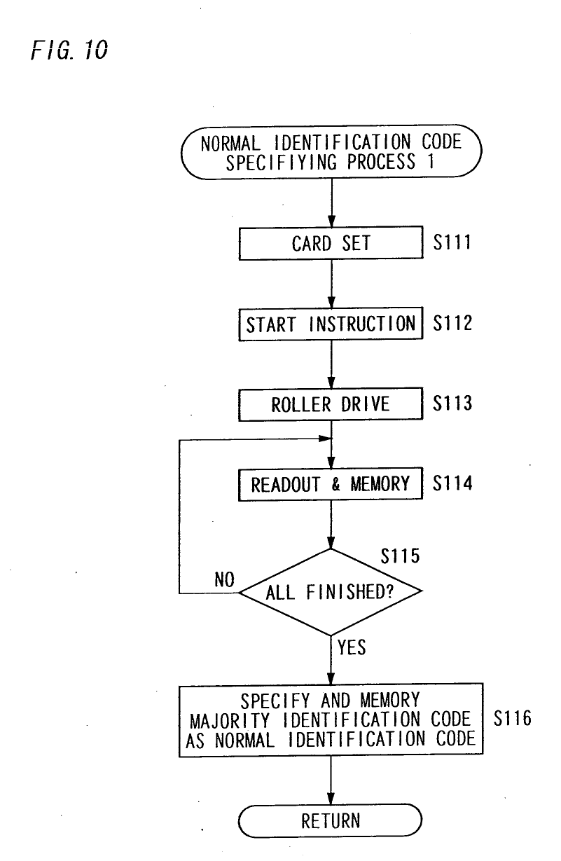

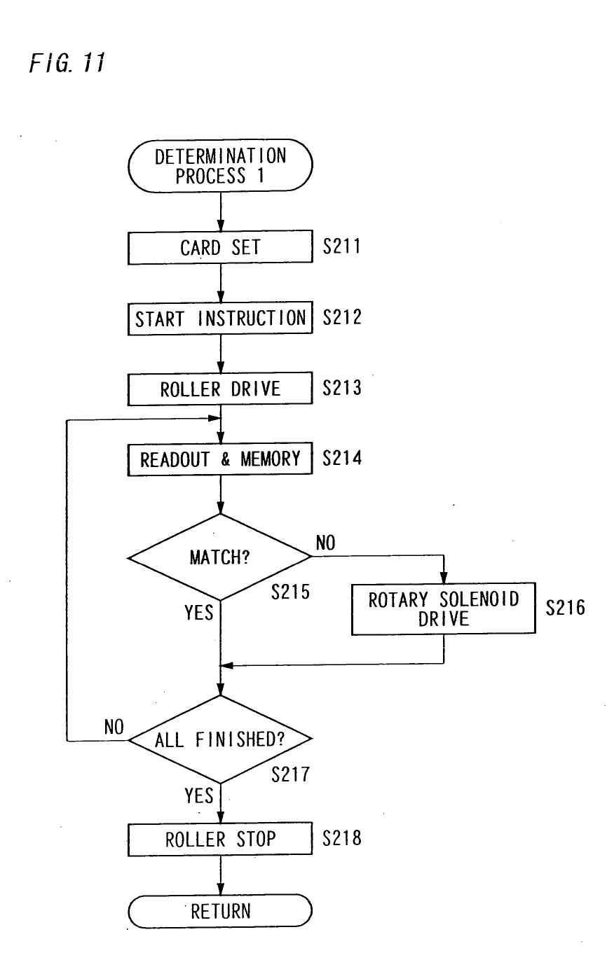

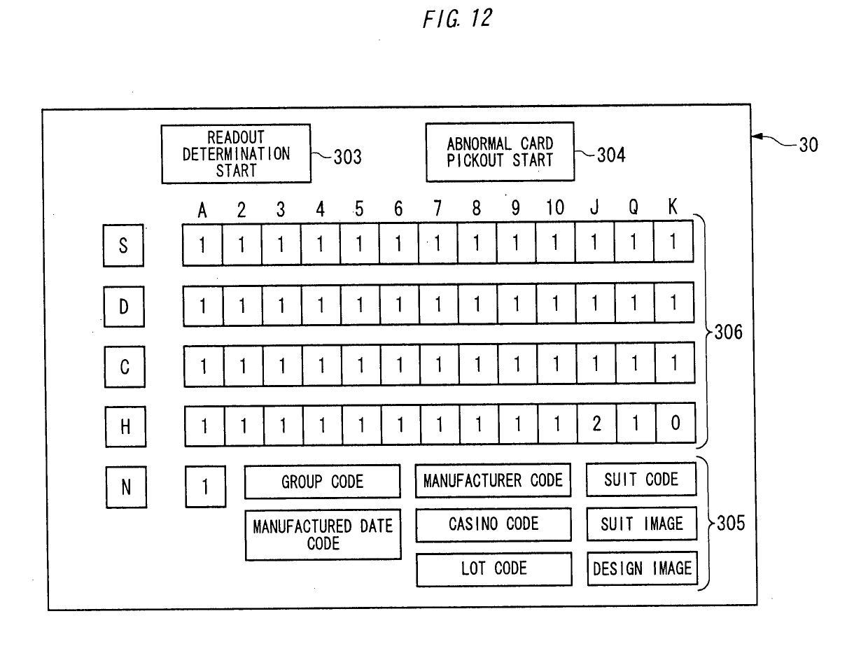

FIG. 10 is a flow chart of the normal identification code specifying process (normal identification code specifying process 1) in the first embodiment, FIG. 11 is a flow chart of the determination process in the first embodiment, and FIG. 12 is an example of display on the monitor 30 in mode 1.

In the normal identification code specifying process 1, first of all, the operator sets the bundle 100 of four decks of playing cards subject to inspection on the card set table 14 (step S111). Then, by pressing the readout determination start button 303 on the operation panel 30, readout start is instructed (step 112). The control device 31 which received the instruction from the input device 302 then drives the carrying out roller 15 as the carrying device 70, and the carrying rollers 16 and 17 (step 113). The playing cards 10 are then sent out one by one from the bundle 100 of playing cards which are set up. Simultaneously with the startup of this roller drive, the ultraviolet lamp 19 is turned on. At that time, the sorting piece 24 is always facing upward, and the playing cards carried to the carrying roller 17 are all stacked in the normal card stacker 27.

The control device 31 stores the identification code read out from the carried playing card 10 in the memory device 291 (step S114). Here, as the ultraviolet lamp is on, the ink of the identification code develops the color and the identification code may be read out by using the ultraviolet light sensor 20.

Next, whether or not the read out has been made for all four decks of playing cards is determined (step S115). When it is not completely finished (No in step 115), the processing returns to step 114 in order to readout and store the identification code on the next card. When the readout for all cards is finished (Yes in step S115), the most common code among the stored identification codes is specified as the normal identification code, and by storing it in the normal identification code memory device 2911 (step S117), the normal identification code specifying process is finished.

When the identification codes on all four decks are the same, only one common identification code is specified as the normal identification code. On the other hand, if the identification codes for each of the four decks is different, the codes are specified as normal identification codes from the most common to the least common of the numbers of readout.

In the determination process 1, the operator first of all resets the bundle 100 of playing cards stacked in the stacker 27 by the normal identification code specifying process 1 (step S211). Next, by pressing the abnormal card pick out start button 304 of the operation panel 30, the operator instructs start (step S212). In responding to this start up instruction, the carrying out roller 15 and the carrying rollers 16 and 17 are operated (step S213). Simultaneously with the start up of the roller operation, the ultraviolet lamp 19 is turned on. At this point in time, the sorting piece is facing upward, and a playing card carried to the carrying roller 17 is carried to the normal card stacker 27.

The readout device 60 respectively reads the identification code, suit indication and design from the playing cards 10 to be carried one by one, to produce respective readout data. The determination device 292 carries out comparison using the identification code determination device 2921, the identification code readout data and the normal identification code stored in the normal identification memory device 291 (step S214).

It is then determined whether the identification code readout data and the normal identification code match or not (step S215), and in the case of not matching (No in step S215), the rotary solenoid 25 is driven to lead the playing card to the abnormal card stacker 28 (step S216). Then, whether or not the inspection is finished for all playing cards is determined (step S217). Here, using a sensor, not illustrated, provided on the card set table 14 of the inspection apparatus 1, whether or not the inspection is finished for all playing cards is determined depending on whether or not there is a playing card remaining on the card set table 14. For any card not having the identification code, the identification code readout data is recognized as an error code, and the result is always No at the step S215 and the rotary solenoid starts to operate (step S216).

On the other hand, if the card is determined to be matched at the step S215, that is, the card is a normal playing card (Yes in step S215), it is determined whether or not all cards are finished without operating the rotary solenoid 25 (step S217). When all cards are determined to be finished (Yes in step S217), the operation of the carrying out roller 15 and the carrying rollers 16 and 17 is stopped (step S218) and the determination process is finished. On the other hand, when all cards are not finished (No in step 216), processing returns to the step S214 and the readout and comparison processes are carried out on the next playing card.

In this determination process, in parallel with the determination of the abnormal playing card, group information, manufacturing date information, manufacturer information, casino information, and manufacturing lot information contained in the readout identification code are analyzed and displayed on the monitor 30. Also, the suit code, suit indication, and design are readout and the result is displayed on the monitor 30.

For such processing, the monitor 30 has the above stated readout determination start button 303 and the abnormal playing card pick out start button 304, the readout data display device 305 for reporting and displaying what is the read out code or information, and the suit displaying device 306 for displaying the suit and number of cards of the read out playing cards 10.

The suit display device 306 displays spades in the S row, diamonds in the D row, clubs in the C row, hearts in the H row, and jokers in the N row, and the upper row of A-K indicates the rank. Each segment of the suit display device 306 respectively displays the number of cards read out based on the suit readout data produced by reading the suit display. The example of FIG. 12 is the display when inspection is performed on one deck as one group, and J of H is indicated as 2, showing the abnormal condition that there is one too many J of H. Also, the K of H is indicated O, showing the abnormal condition that the K of H is missing. The existence of an abnormal condition is reported at two places by changing color and blinking light with sound. When the inspection is performed on four decks of playing cards, 4 is displayed for the normal condition, and the condition displaying 3 or 5 is an abnormal condition.

A code displaying button is further provided on the monitor 30, and by pressing the code display button, an image displaying the content of the identification code and abnormal code is displayed, and the content of the abnormal code may also display the suit of a playing card. In doing so, the group to which the abnormal playing card should originally belong is specified and by returning the playing card to the group in which it should belong, it is possible to reuse the playing cards as a normal group.

As stated above, at the step S214, by comparing the identification code it is determined whether or not the card is a normal playing card or a abnormal playing card, but in parallel with this determination, determination may be made by the design. In such a case, the design readout device 60 compares the design readout data produced by the CCD camera 22 with the reference design data stored in the reference design data memory device 2912 by the design determination device 2922, and determines whether or not both match. If the two do not match, the playing card is led to the abnormal card stacker 28 by operating the rotary solenoid.

[Second Embodiment of the First Inspection Process]

In the first embodiment, the normal identification code is specified by a so-called majority decision, but in the second embodiment the normal identification code is specified by read out of the sample card. At least one sample card is prepared for a group constituting one deck or a plurality of decks. In the case where a group is constituted by a plurality of decks, when each deck has a different identification code, a sample card is prepared for each deck, while if the identification code of each deck constituting a group is common, only one sample card is prepared. The sample card is not used in a normal card game but used in this inspection process to specify the normal identification code.

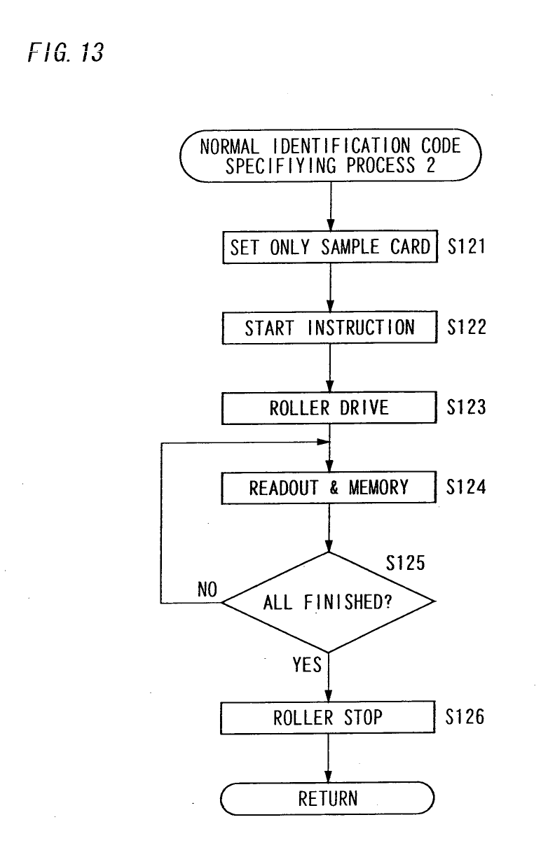

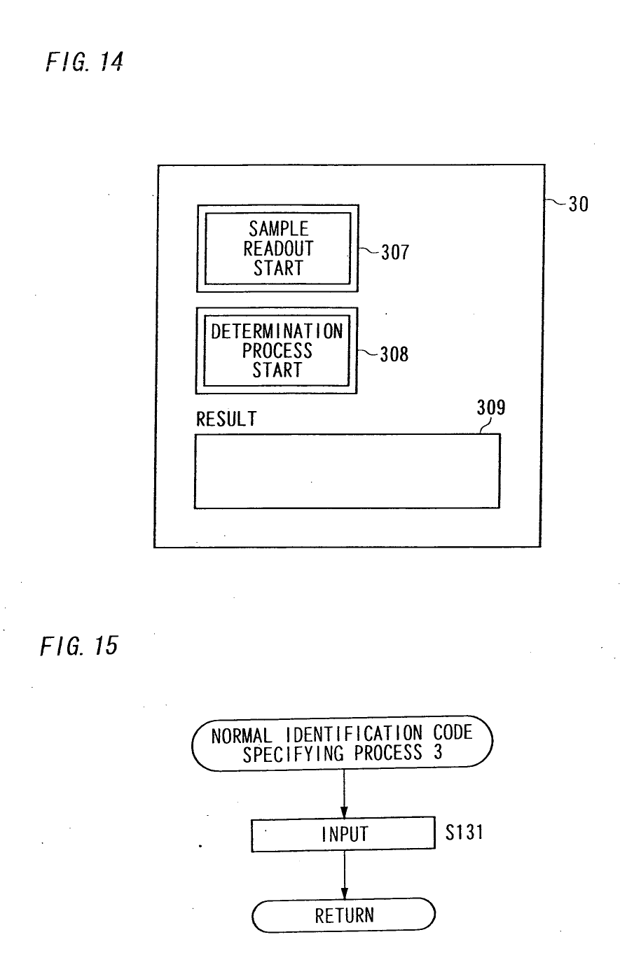

FIG. 13 is a flow chart of the normal identification code specifying process in the second embodiment (normal identification code specifying process 2). Also, FIG. 14 is a display example of the monitor 30 in the second embodiment.

In the normal identification code specifying process 2, only a sample card is set at first in the card setting table 14 (step S121). At that time, when the normal identification card is different on each of the four decks, their 4 sample cards are set. Then, when the operator instructs start-up by pressing the sample readout start button 307 of the operation panel 30 (step S122), the operator starts the operation of a roller (step S123), and reads and stores (step S124) the identification code of the sample card. At that time, the ultraviolet lamp 19 is turned on.

When there are a plurality of sample cards, that is, the identification code differs for each of the four decks, the readout and storage on the sample card are repeated (No in step S125). After readout of all sample cards is finished (Yes in step 125), the operation of the roller is stopped (step S126) and the normal identification code specifying process is finished.

The determination process is conducted similarly to the determination process 1 depicted in FIG. 11. The start instruction of the step S212 in made by pressing the determination process start button 308 of FIG. 14. Also, the result of the determination is text displayed on the result display device 309.

[Third Embodiment of the First Inspection Process]

In the third embodiment, the normal identification code is specified by the manual input of the operator. The identification code representing each deck or the identification code representing a group of four decks is indicated on the case for containing a bundle of playing cards, and the operator is able to learn the identification code corresponding to that group by observing that indication.

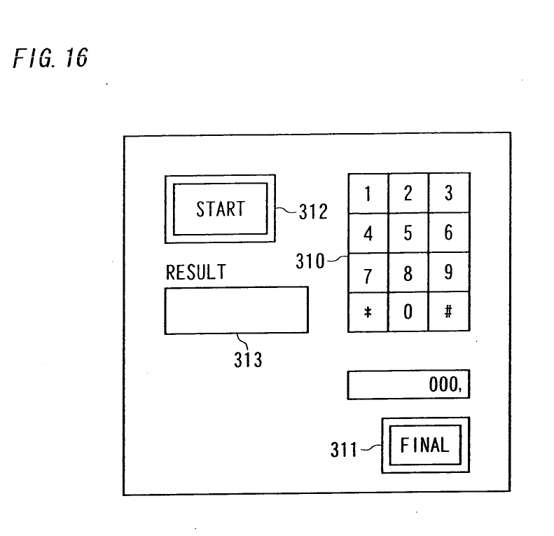

FIG. 15 is a flow chart of the normal identification code specifying process (normal identification code specifying process 3) in the third embodiment. FIG. 16 is a display example of the monitor 30 in the third embodiment. In the normal identification code specifying process 3, the operator inputs the normal identification code using the ten-key 310, and presses the set button 311 (step S131). In this way, the normal identification code is specified, and next, the determination process is carried out, similarly to the determination process 1.

Here, in the determination process in the third embodiment, at the step S212, the operator instructs the start by pressing the start button 312 displayed on the monitor 30. In the third embodiment, the result of determination is text displayed on the result display device 313 similar to the second embodiment.

[Fourth embodiment of the First Inspection Process]

In the fourth embodiment, when it is determined that there is an abnormal card in the determination process, the operation of the roller is stopped at that point in time and the readout of the card thereafter is suspended.

For a casino adopting a policy of disposing of all of a plurality of playing cards when an abnormal card is included in the plurality of playing cards subject to inspection, if the inspection is stopped at the point in time when the existence of the abnormal card is revealed, the inspection process may be performed in a shorter period of time.

After the inspection is stopped due to the existence of an abnormal card, the abnormal card is removed and the inspection process may be resumed on the remaining playing cards which have not been inspected. By repeating this operation, all abnormal cards may be removed from the plurality of playing cards subjected to inspection.

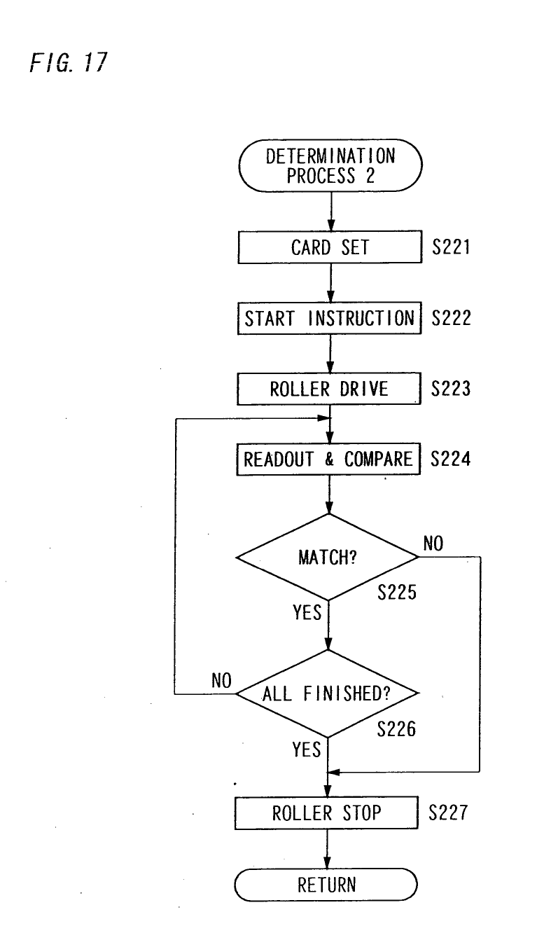

FIG. 17 is a flow chart of the determination process (determination process 2) in the fourth embodiment. In the fourth embodiment, the identification is specified by the normal identification code specifying process in the above first embodiment through the third embodiment, or other normal identification code specifying processes. In the determination process 2, the process from setting the card at the step S221 until the step S227 finishing the determination process without an abnormal playing card, is the same as the process of the step S211 to the step S217 of the determination process 1 depicted in FIG. 11, and the explanation thereof is omitted.

In the determination process 2, if the read out identification code and normal identification code do not match (No in step S225), the operation of the carrying out roller 15 and carrying roller 16 and 17 are stopped (step S227) and the determination process is finished.

[Fifth Embodiment of the First Inspection Process]

In the fifth embodiment, in a plurality of playing cards subjected to the inspection, the identification code read from the first playing card (first identification code) is deemed the normal identification card, and for the second playing card or thereafter, normal or abnormal is determined by whether or not the first identification code and such identification codes match.

The read out result of the identification code is displayed on the monitor 30 from time to time in relation to the suit of that playing card. In doing so, it can be specified which suit of playing card is normal and which suit of playing card is abnormal.

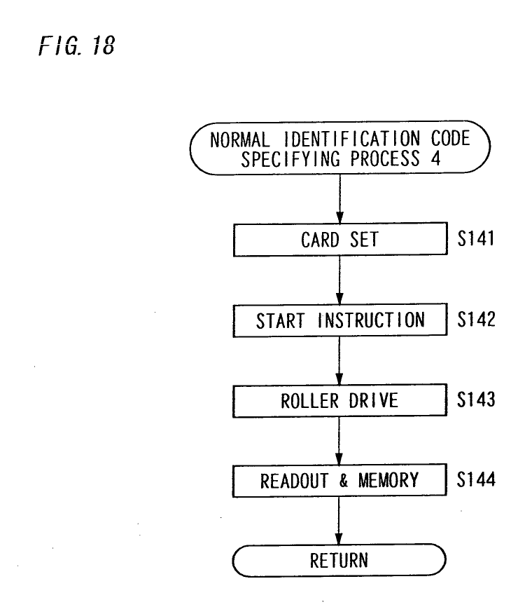

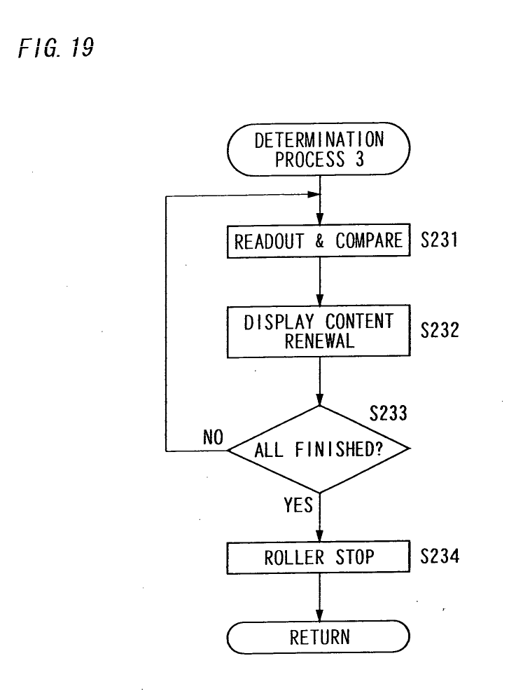

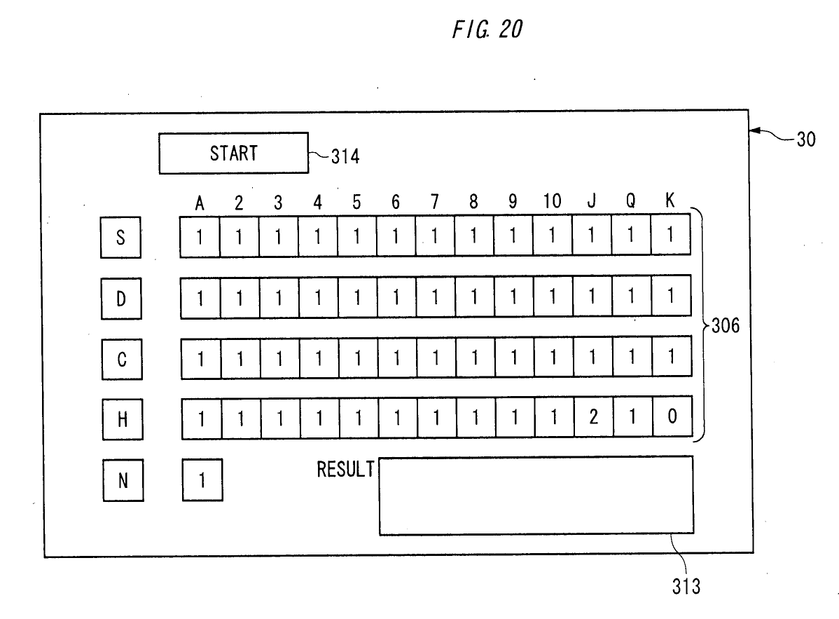

FIG. 18 is a flow chart of the normal identification code specifying process (normal identification specifying process 4) in the fifth embodiment. FIG. 19 is a flow chart of the determination process (determination process 3) in the fifth embodiment. FIG. 20 is a display example of the monitor 30 in the fifth embodiment.

In the normal identification code specifying process 4, the operator at first sets a bundle 100 of a plurality of playing cards subjected to the inspection on the card set table 14 (step S141). Then, start-up is instructed by pressing the start button 314 on the operation panel 30 (step S142). As a result, the operation of the roller commences (step S143). The ultraviolet lamp is turned on at the same time. Then, the playing card 10 at the bottom of the bundle 100 of playing cards is carried out, and the identification code, suit indication and design are respectively read out. The read out identification code is stored as the normal identification code in the normal identification code memory device 2911 (step S144) Using the suit indication read out at that time, the suit is determined by the suit determination device 2923 and the content of display of the monitor 30 is renewed.

After that, without stopping the operation of the roller, the determination process for the following playing card is commenced. In the determination process 3, the identification code of the playing card is read out and compared with the normal identification code stored in the normal identification code memory device 2911 (step S231), and matching/not matching is determined. Then, the numerical figure of the segment corresponding to the suit determined by the suit determination device 2923 based on the readout of the suit display is incremented (step S232). At that time, if the read out identification code and the normal identification code do not match, the color of the numerical figure of the segment is changed or made to blink.

Then, whether or not the determination is finished is judged (step S233), and when finished (Yes in step S233), the operation of the roller is stopped (step S234) and the determination process is finished. If all of the determinations are not finished (No in step S233), the step S231 and step S232 are repeated.

After the determination process is finished, the result is displayed on the result display device 313 of the operation panel.

When four decks have respectively different identification codes, the identification codes of the first four playing cards are not made to be the normal identification code directly, and the identification code recognized first is specified as the normal identification code. Thereafter, when an identification code different from the specified identification code is read out, they are specified sequentially as normal identification codes. This procedure is performed until there are four normal identification codes.

[Variation for the Fifth Embodiment]

In the above described the fifth embodiment, the card to be readout at first, that is, the card which is set at the bottom on the card set table 14, may be the sample card. When four decks respectively have different identification codes, the first four cards (4 cards from the bottom) may be the sample cards.

[Second Inspection Process]

In the first inspection process, after the normal identification code is specified at first, by determining whether or not the identification code readout from the playing card subjected to the inspection matches its normal identification code, it is determined whether the playing card is normal or abnormal. On the other hand, in the second inspection process, without determining the normal identification code as the standard, whether or not an abnormal card is included in a plurality of playing cards subjected to the inspection is determined by relative comparison. In this second inspection process, the identification code is common in a group comprising a plurality of decks.

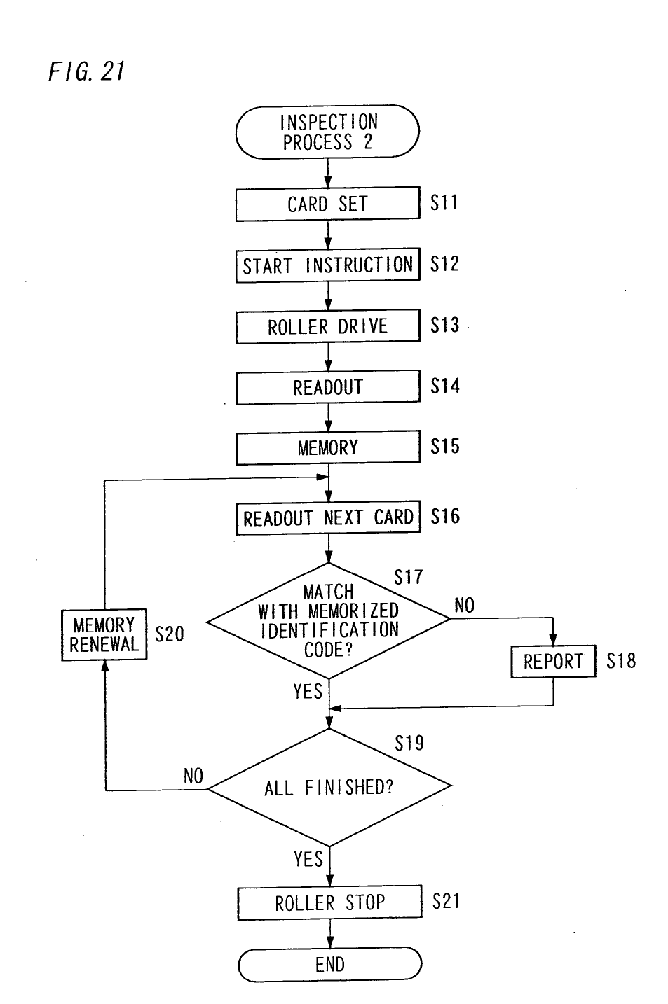

FIG. 21 is a flow chart of the second inspection process (inspection process 2). In the inspection process 2, the operator at first sets a plurality of playing cards to be inspected on the card set table 14 (step S11). Then, commencement is instructed using the operation panel (step S12) to commence the operation of the roller (step S13). The inspection apparatus first reads the identification code on the first playing card (step S14) and stores it (step S15).

Then, the inspection apparatus reads the identification code of the next playing card (step S16), and determines whether or not it matches the identification code stored before (step S17). If it does not match (No in step S17), it reports to that effect (step S18) and the roller is stopped (step S21). In case of matching, it determines whether or not the inspection is finished for all of the playing cards (step S19), and if not finished (No in step S19), the identification code stored in step S15 is updated to the identification code read by step S16 (step S20) and the identification code of the next playing card is read out (step S16).

By repeating the renewal of readout, determination and storage, it is determined whether or not all identification codes match on a plurality of playing cards subjected to the inspection. If the inspection is finished for all playing cards at step S19 (Yes in step S19), the roller is stopped (step S21) and the inspection process is finished.

[Second Inspection Apparatus]

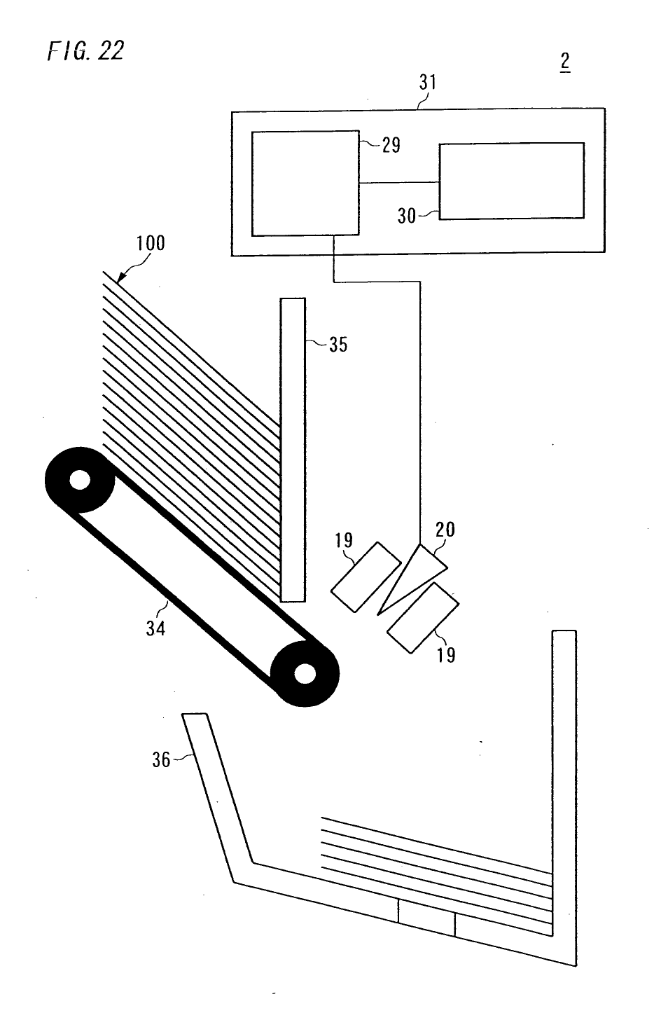

FIG. 22 is a general side view drawing showing the second embodiment of the inspection apparatus. With the playing card inspection apparatus 2, the carrying out belt 34 is provided slantingly in place of the carrying out roller 15, carrying roller 16 and 17 of the playing card inspection apparatus 1. In the second embodiment, there is no CCD camera for reading the suit or CCD camera for reading out the design of the playing card 10. Furthermore, there is no sorting piece or rotary solenoid for picking out an abnormal card. By adopting such a structure, the miniaturization of the apparatus may be accomplished.

The bundle of playing cards 100 placed on the carrying out belt 34 hits the wall member 35 by its own weight because of the slant of the carrying out belt 34. There is a space between the lower end of the wall member 35 and the carrying out belt 34 sufficient for one playing card to go through, and the bottom card of the bundle 100 of playing card 10 is carried to a position opposite to the ultraviolet light sensor 20 by the revolution of the carrying out belt 34. The playing card 10 detaches from the carrying out belt 34 as it is further carried out by the carrying out belt 34 and dropped down to the stacker 36. In the second embodiment, the inspection apparatus has the control device 31 including the memory determination unit 29, the monitor 30, and the ultraviolet lamp 19 similar to the first embodiment.

[Third Inspection Apparatus (2 Rollers Pair Type)]

The third inspection apparatus is an inspection apparatus of the type having 2 sets of carrying roller pairs to maintain and carry the playing card at the time of readout of the identification code, etc.

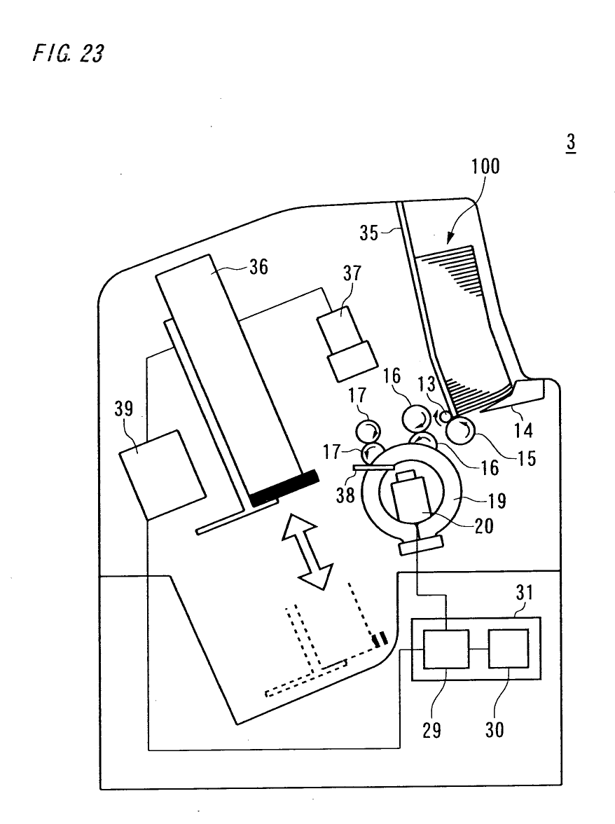

FIG. 23 is a general side view showing the third embodiment of the inspection apparatus. The inspection apparatus 3 covered by the third embodiment has the card set table 14 to set the bundle of playing cards subjected to 100 inspection, the wall member 35 and the carrying out roller 15. In the third embodiment, the playing card 10 subjected to inspection is set on the card set table 14 with the side on which the identification code is printed facing down.

The upper side of the card set table 14 is curved to guide the playing card 10 toward the carrying out roller 15 so that the bundle of playing cards 100 hits the wall member 35. The carrying out roller 15 is used alone, and operated to revolve in a direction of the arrow in the drawing to carry out the bottom playing card of bundle of playing cards 100.

At the upper part of the carrying out roller 15, a freely movable steel ball weight 13 is provided at a fixed position. The lowest playing card on the card set table 14 is pressed down against the carrying out roller 15 by the steel ball weight 13. As a result, the playing cards 10 are reliably carried out one by one. Moreover, in the inspection apparatus 3, the playing card 10 subjected to inspection is set with its reverse side, that is, the side on which the design is printed, facing upward.

The inspection apparatus 3 further has the carrying rollers 16 and 17 provided with a prescribed distance in between, and the ultraviolet lamp, CCD camera 20 and the mirror 38 are provided below the two carrying rollers. The carrying roller pair 16 and carrying roller pair 17 are rollers which carry the playing card while maintaining the playing card at the time the identification code, etc. of the playing card 10 are read. On the upper side of the carrying roller pair 16 and 17, the CCD camera 38 is provided to read the design on the reverse side of the playing card 10, and to read the suit display on the surface of playing card 10 by using the mirror 38.

The playing cards 10 are carried out one by one by the carrying out roller 15, in an orderly manner to a position opposite to the CCD camera 20 and CCD camera 37. The CCD camera 20 and CCD camera 37 perform sensing at an appropriate timing according to the carrying out of the playing cards 10.

In the inspection apparatus 3, the CCD camera 37 directly reads out the design and also reads out the suit display on the front side by using the mirror 38, so that simplification and miniaturization of the apparatus can be contemplated compared with the first embodiment that is provided with two CCD cameras for reading each of them.

The inspection apparatus 3 also has the stacker 36 for stacking the playing card for which inspection is finished, and the motor 39 for moving the stacker 36 up and down according to the number of playing cards 10 stacked on the stacker 36. Also, similar to the inspection apparatuses 1 and 2, the inspection apparatus 3 has the control device 31 including the memory determination unit 29 and monitor 30.

[Fourth Inspection Apparatus (1 Roller Pair Type)]

Whereas the third inspection apparatus is provided with two groups of carrying roller pairs, the fourth inspection apparatus is provided with one carrying roller pair, and reads out the identification code from the playing card held in that one carrying roller pair.

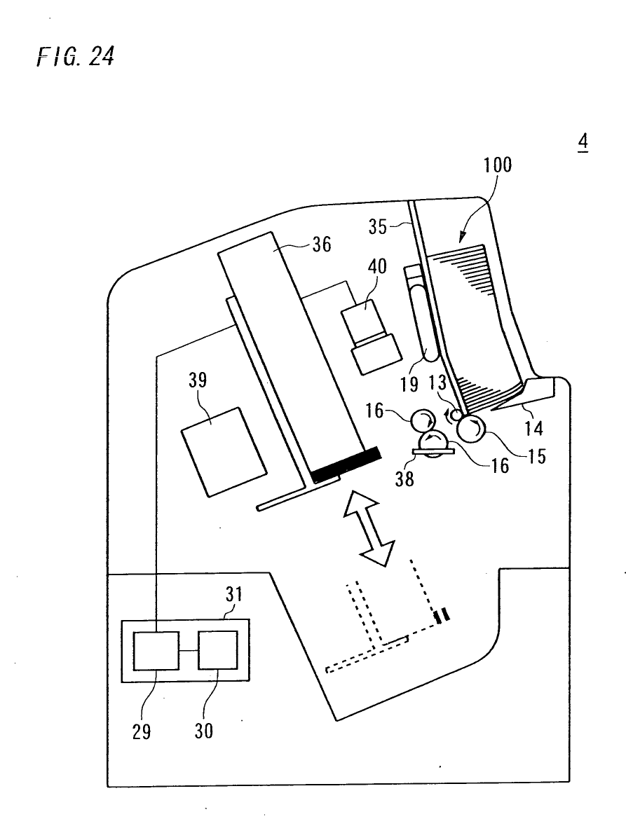

FIG. 24 is a general side view drawing showing the fourth embodiment of the inspection apparatus. The inspection apparatus 4 covered by the fourth embodiment has, similar to the inspection apparatus 3, the card set table 14 to set the bundle of playing cards 100 subject to inspection, the wall member 35 and the carrying out roller 15. In the fourth embodiment, the playing card 10 subject to inspection is set on the card set table 14 with the side on which the identification code is printed facing up.

The carrying roller 16 is provided at the end of a carrying route of the carrying out roller 15. In the inspection apparatus 4, there is no carrying roller corresponding to the carrying roller 17 of the inspection apparatus 3. That is to say, the identification code, etc. are read out under the condition where the playing card is held only by the carrying roller 16. In the inspection apparatus 4, the ultraviolet lamp 19 is provided between both rollers to irradiate the ultraviolet light to the portion of the playing card 10 which has not yet passed the carrying roller 16.

Further, in the inspection apparatus 4, the mirror 38 is provided to reflect the bottom side of the playing card 10 toward the CCD camera 40. Therefore, the CCD camera 40 is able to read all of the identification codes 10, suit display and design of the playing card 10 while supported only by the carrying roller 16. The CCD camera 40 directly senses the identification code and suit display of the playing card held on a cantilever by the carrying roller 16 and the bottom side design is sensed by the image reflected by the mirror 38.

The structure of the stacker 36 and motor 39 is same as the inspection apparatus 3. Also, the point of having the structure of the control device including the memory determination device 29 and monitor 30 is the same as the inspection apparatus 3.

In the above described embodiments, it is explained that the identification code is given inherently to each deck, but the present invention is not limited to this. The identification code may be given, for example, inherently to each of the playing cards. In such a case, at the time of inspecting four decks of playing cards, the inspection apparatus may recognize the code of 213 (53 cards×4 decks) as the normal identification code, that is, the identification code possessed by the normal playing cards constituting the prescribed group.

The inspection apparatus explained in the above embodiments may be incorporated into a shuffling apparatus for shuffling the playing cards at each corner of the casino. Many shuffling apparatuses are provided with a mechanism for moving the playing cards one by one. The inspection apparatus incorporated in a shuffling apparatus reads out the identification code and, when necessary, other information from the playing cards moved by the carrying mechanism of this shuffling apparatus. According to this embodiment, the card moving mechanism of the shuffling apparatus is used not only for shuffling but also for carrying out inspection. Accordingly, the inspection apparatus may be offered at a lower price. Furthermore, with this embodiment, the inspection may be carried out while a game is in progress, the reliability of the game is improved, and the pace of a game is increased. Also, when inspecting the cards in front of guests, it is natural for guests to want to learn the nature of an abnormality if there was any abnormality, and it can accommodate this demand. At the very least, a losing guest cannot accept the result of a game in which foul play was committed by mingling an abnormal card. Depending on the nature of a game, which guest holds what suit is recognized by game players, a leader or onlookers during the game. Therefore, by specifying the suit of the abnormal card, it may be possible to specify to which guest the card was dealt.

The inspection technique of the playing card explained above is not only to discover an illicit act performed in a casino but also to contribute to specifying a dishonest player by concurrently using a monitor camera, etc. For example, it specifies at which table a group containing the abnormal card is used, and from the image take by the monitor camera set at that table, the dishonest player can be specified by discovering who is handling the abnormal card.

[Additional Note]

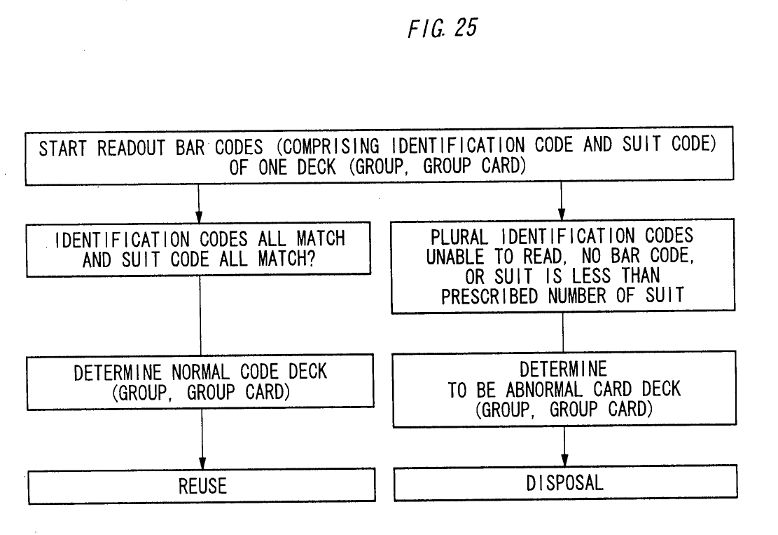

A summary of the inspection technique will be given as an additional note hereafter. As is clear from the above explanation, the technique mentioned hereafter corresponds to the working forms explained up to now. Also, FIG. 25 to FIG. 27 inclusive correspond to the following inspection techniques.

1. (FIG. 25) With this inspection technique, the identification code of the playing card provided on the front side of the playing card itself is read out and stored by the playing card determination apparatus having the readout means (identification code readout device) and the memory determination device and reporting device. Its identification code is a code indicating the playing cards constituting one group (comprising one or a plurality of decks), which can be read out by the readout means such as the light sensor, magnetic sensor or camera, and also, the group code invisible to the naked eye under normal usage conditions. The identification consists, for example, of numerical figures, marks, bar codes, etc. When all read out identification codes are matched, the group is determined to be a normal group, and when there is a code different from the identification code which has been read or to be read (including unreadable, no bar code, etc.), the group is determined to be an abnormal code. Whether one read out group is the normal group or an abnormal group is reported by the reporting means. For example, the normal group or normal card is reused, and an abnormal group or abnormal card is disposed of.

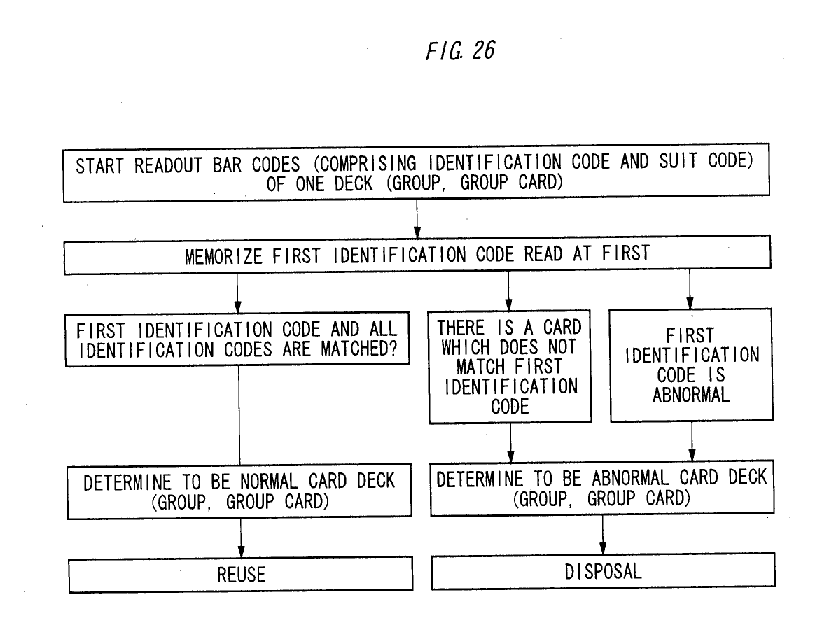

2. (FIG. 26) Preferably, the identification code read at first is the first identification code. If this first identification code and the identification code read subsequently are all matched, the group is determined to be a normal group. On the other hand, if, in the identification code read or to be read, there is a code different from the first identification code (including unreadable, no bar code, etc.), the group is determined to be an abnormal group.

There is a possibility that the first identification code is abnormal. Typically, a case where an abnormal code is read first. In that case, the identification codes which do not match are readout continuously. If the first identification code is abnormal, that group is determined to be an abnormal code.

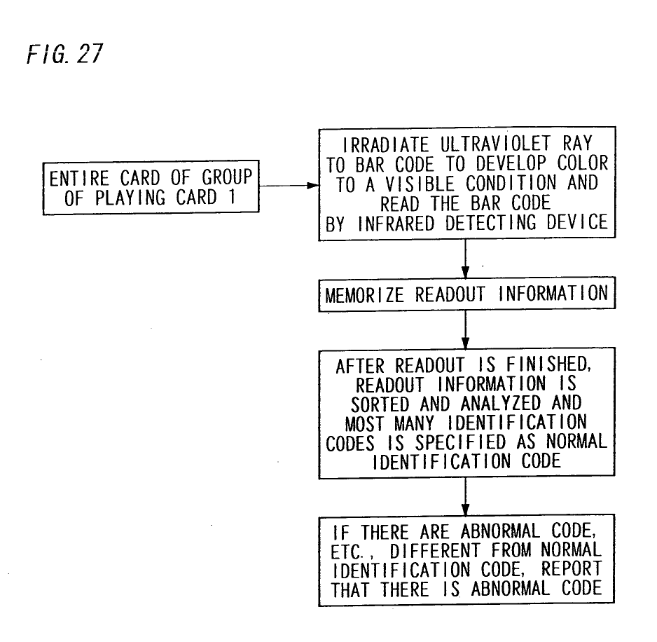

3. (FIG. 27) Preferably, after the identification codes of all cards are read and stored, the many identification codes are specified as the normal identification code. If there is an abnormal code different from this normal identification code (including no identification code or unreadable code), or a missing card or an extra card is detected, the reporting means reports that there is an abnormality in the playing cards constituting the one group.

Preferably, the playing card determination apparatus has the suit determination means for determining the suit of playing cards. The result of readout of the suit is added to the content of the readout memory for the identification code. The reporting device is a monitor for reporting the suit of the abnormal card.

Preferably, the identification code is printed using ink which develops color or emits light when special light such as ultraviolet light is irradiated on the playing card, or using ink which develops color (or emits light) when irradiated by the specific light and when the effect of the specific ray is gone, becomes invisible to the naked eye.

Preferably, the identification code is a bar code. Also, the identification code comprises the group code and manufacturing date code. Further, the identification code is added with the casino code.

Industrial Applicability

The present invention is suitably utilized in the casino business world. Concretely, the present invention relates to technology for discovering in a casino an abnormal playing card mixed in with genuine playing cards for illicit purposes.

1. An inspection apparatus for inspecting a plurality of playing cards, comprising;
a code readout device configured to produce readout data by reading an identification code provided on a playing card, the identification code representing that the playing card is a member of a prescribed group; and
a determination device for determining, based on the readout data, that an abnormal playing card that is not a member of the prescribed group is included in the plurality of playing cards.

2. The inspection apparatus of claim 1, wherein
the identification code is provided on the playing card under a condition invisible to the naked eye under normal usage conditions.

3. The inspection apparatus of claim 2, further comprising;
a light source fir irradiation prescribed light on the playing card, and wherein
the identification code becomes readable by the readout device upon receiving the prescribed light.

4. The inspection apparatus of claim 1, further comprising;
a reporting device for reporting the result of the determination by the determination device.

5. The inspection apparatus of claim 4, further comprising;
a suit display readout device for reading out a suit indication of the playing card, and wherein
the reporting device is a monitor for displaying the result of the determination and reporting the suit of an abnormal playing card by displaying suits read out by the suit display readout device.

6. The inspection apparatus of claim 1, wherein
in the event that the code readout device cannot read out the identification code of any of said plurality of playing cards, the determination device determines that the abnormal playing card that does not constitute the prescribed group is included in the plurality of playing cards.

7. The inspection apparatus of claim 1, further comprising;
a normal identification code memory device for storing the normal identification code corresponding to the prescribed group, and wherein
the determination device compares the identification code read out by the code readout device and the normal identification code stored in the normal identification code memory device, and in the event that the identification and the normal identification code do not match, determines that an abnormal playing card that does not constitute the prescribed group is included in the plurality of playing cards.

8. The inspection apparatus of claim 7, wherein
the memory device stores the identification code read out by the code readout device as the normal identification code.

9. The inspection apparatus of claim 8, wherein
the identification code stored as the normal identification code is the most common identification code readout from the plurality of playing cards.

10. The inspection apparatus of claim 8, wherein
the identification code stored as the normal identification code is an identification code first readout from the plurality of playing cards.

11. The inspection apparatus of claim 8, wherein
the identification code stored as the normal identification is an identification code readout from a sample playing card different from the plurality of playing cards.

12. The inspection apparatus of claim 7, further comprising;
an input device for an operator to input the identification code, and wherein
an identification code to be stored as the normal identification code is the identification code input from the input device.

13. The inspection apparatus of claim 7, wherein
the prescribed group is constituted by a plurality of decks, and the plurality of decks respectively have different normal identification codes; and
the determination device determines that an abnormal card that does not constitute the prescribed group is contained in the plurality of playing cards when an identification code readout by the code readout device does not match any of the codes.

14. The inspection apparatus of claim 1, wherein
the determination device determines that an abnormal card that does not constitute the prescribed group is contained in the plurality of playing cards by comparing each of the identification codes respectively read out from the plurality of playing cards with each other.

15. The inspection apparatus of claim 1, further comprising;
an abnormal playing card pick out device for picking out the abnormal playing card that does not constitute the above prescribed group.

16. The inspection apparatus of claim 15, wherein
the abnormal playing card pick out device picks out the abnormal playing card by arranging the abnormal playing card for which readout by the readout device is finished at a different place to the other playing cards.

17. The inspection apparatus of claim 15 further comprising;
a carrying device for sequentially sending the plurality of playing cards to the code readout device and the abnormal playing card pick out device picks out the abnormal playing card by stopping the motion of the carrying device when an abnormal playing card is determined to be included by the determination device.

18. The inspection apparatus of claim 1 further comprising;
a design readout device for reading out designs indicated on the plurality of playing cards, and wherein
the determination device further determines, based on the design read out by the design readout device, whether or not an abnormal playing card that does not constitute the prescribed group is included in the plurality of playing cards.

19. The inspection apparatus of claim 18, further comprising;
a suit display readout device for reading out the suit of the playing card displayed on the side obverse to the side on which the design is displayed, and wherein
the code readout device, said design readout device and the suit indication readout device are a common readout device;
and further comprising
a mirror reflecting the design or said suit toward the common readout device.

20. The inspection apparatus of claim 19, further comprising;
a stacker for stacking the plurality of playing cards; and
at least one pair of rollers, and a carrying device for carrying by the pair of rollers the playing cards stacked in the stacker, in order, to a position opposite to the single readout device, and wherein
the mirror reflects the design or suit on the free edge of a playing card held at a single side by the pair of rollers toward the single readout device.

21. A playing card comprising;
an identification code representing a group to which the playing card belongs, the code being invisible to the naked eye under normal condition and being identifiable by a prescribed identification device.

22. The playing card of claim 21, further comprising;
at least two of said identification codes, these two identification codes having point symmetry about the center of the playing card.

23. The playing card of claim 21, wherein
the identification code is printed with paint that becomes visible when irradiated by prescribed light.

24. The playing card of claim 23, wherein
the identification code is a bar code.

25. The playing card of claim 23, wherein
the identification code is printed at a position not overlapping a suit indication of the playing card.

26. The playing card of claim 21, wherein
the identification code includes group information inherent to the group and information of manufacturing date of the group.

27. The playing card of claim 21, wherein
the identification code includes casino information inherent to a casino in which the playing card is used.

28. An inspection method for inspecting a plurality of playing cards comprising;
reading an identification code provided on a playing card, the code being provided on each playing card belonging to a prescribed group to represent the group; and
determining that an abnormal card that is not a member of the prescribed group is included in the plurality of playing cards based on the result of the reading.
